(19) United States
(12) Patent Application Publication
(10) Pub. No.: US 2016/0190754 A1
(43) Pub. Date: Jun. 30, 2016

(54) ELECTRICAL CONNECTOR ASSEMBLY WITH ROTATABLE FIRST AND SECOND CONNECTORS

(71) Applicant: FOXCONN INTERCONNECT TECHNOLOGY LIMITED, Grand Cayman (KY)

(72) Inventor: ROBERT GERALD MCHUGH, Everygreen, CO (US)

(21) Appl. No.: 14/583,825

(22) Filed: Dec. 29, 2014

(51) Int. Cl. H01R 35/04; H01R 13/502; H01R 43/26

(52) U.S. Cl. CPC H01R 35/04; H01R 43/26; H01R 13/502

(57) ABSTRACT

An electrical connector assembly includes rotatable first and second connectors, the first connector includes a first housing having a first locking thereof and a plurality of first contacts retained in the first housing, and the second connector includes a second housing having a second locking portion thereof and a plurality of second contacts retained in the second housing. When the second connector mates with the first connector, the second connector is inserted to stay at a first position, and then rotated relative to the first connector to stay at a second position in which the first locking portion latches with the second locking portion, synchronously, the first and second contacting portions mechanically and electrically contact with each other.

### BACKGROUND OF THE INVENTION

1. Field of the Invention

The present invention relates to an electrical connector assembly including a first connector and a second connector, the second connector can be rotated from a first position to a second position relative to the first connector to synchronously lock and electrically contact with the first connector in the second position.

2. Description of the Related Art

With the light, thin, short, small development trend of the electronic devices, electrical connector is designed smaller and smaller for suitable for the trend. However, it becomes an urgent problem that how to provide reliably holding force between the contracted plug and socket connectors of the electrical connector assembly in order to achieve excellent electrical transmission therebetween.

Therefore, a new design is required.

### SUMMARY OF THE INVENTION

Accordingly, an object of the present invention is to provide an electrical connector assembly having reliably locking feature thereof.

In order to achieve the object set forth, an electrical connector assembly includes rotatable first and second connectors, the first connector includes a first insulative housing defining a circular side wall and a mating cavity surrounded by the side wall, and a plurality of first contacts retained in the side wall and providing a plurality of first contacting portions projecting into the mating cavity from the side wall. The side wall defines a first locking portion thereof. The second connector includes a circular second insulative housing defining an outer face and a second locking portion projecting from the outer face, and a plurality of second contacts surrounding the circular second housing and providing a plurality of second contacting portions exposed upon the outer face. When the second connector mates with the first connector, the second connector is inserted into the mating cavity to stay at a first position, and then rotated relative to the first connector to stay at a second position in which the first locking portion latches with the second locking portion and synchronously the first and second contacting portions mechanically and electrically contact with each other.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector assembly in accordance with the present invention, and showing a first connector disengaging with a second connector;

FIG. 2 is another perspective view of the electrical connector assembly shown in FIG. 1;

FIG. 3 is an exploded perspective view of the first connector shown in FIG. 1;

FIG. 4 is an exploded perspective view of the second connector shown in FIG. 1;

FIG. 5 is a perspective view of the electrical connector assembly, showing the second connector mated with the first connector in a first position;

FIG. 6 is a cross-sectional view of the electrical connector assembly taken along line 6-6 of FIG. 5;

FIG. 7 is a perspective view of the electrical connector assembly, showing the second connector mated with the first connector in a second position; and

FIG. 8 is a cross-sectional view of the electrical connector assembly taken along line 8-8 of FIG. 7.

### DETAILED DESCRIPTION OF THE INVENTION

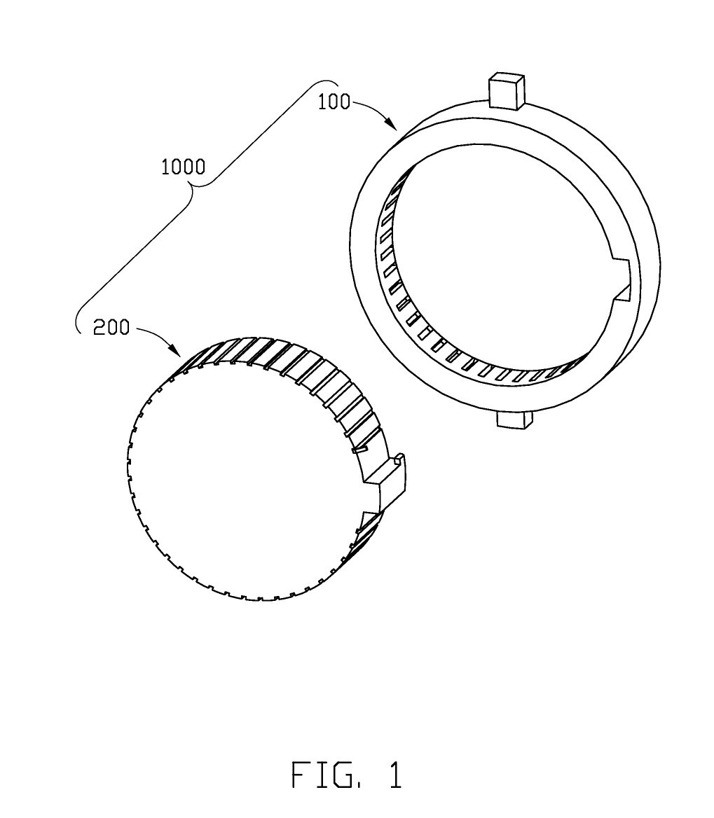

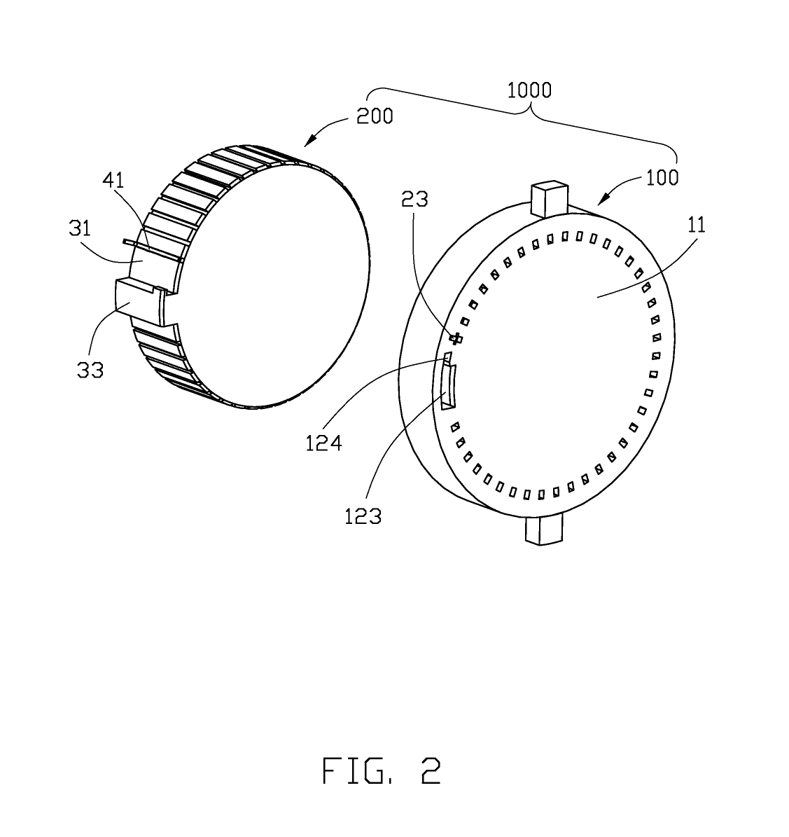

Reference will now be made to the drawing figures to describe a preferred embodiment of the present invention in detail. Referring to FIG. 1 and FIG. 2, the electrical connector assembly 1000 includes a first connector 100 and a second connector 200 mating with the first connector 100.

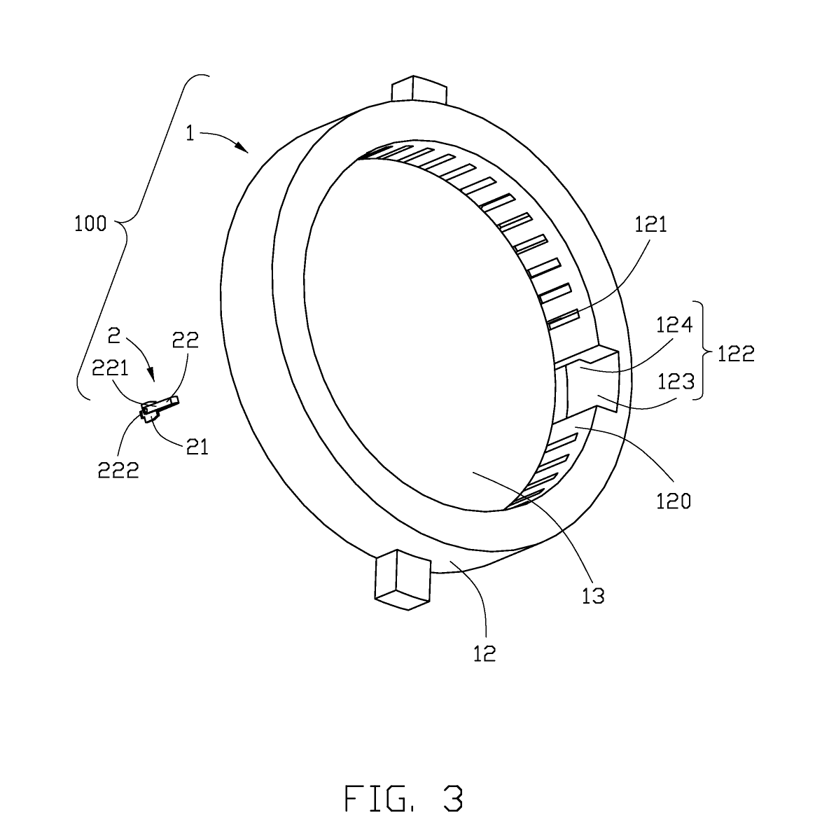

Referring to FIG. 2 and FIG. 3, the first connector 100 includes a first insulative housing 1 and a plurality of first contacts 2 retained to the first housing 1. In this embodiment, only one first contact 2 is shown in the first connector 100. The first housing 1 is round-shaped and defines a bottom wall 11, a round-shaped side wall 12 rose from an outer edge of the bottom wall 11 along a mating direction and a mating cavity 13 surrounded by the side wall 12. The mating cavity 13 is formed by the side wall 12 and the bottom wall 11 commonly. The side wall 12 defines a plurality of first terminal grooves 121 symmetrically arranged around the mating cavity 13 and communicating with the mating cavity 13, and a first locking portion 122 adjacent to the bottom wall 11. The first locking portion 122 defines a receiving slot 123 running through an upper face of the side wall 12 along the mating direction and an inner face 120 of the side wall 12 to communicate with the mating cavity 13, and a locking slot 124 set in the side wall 12 to communicate with the receiving slot 123. The locking slot 124 is separated from the mating cavity 13 and closed at least at an upper portion thereof.

Each first contact 2 defines a retaining portion 21, a resilient contacting arm 22 bending inwardly from an upper portion of the retaining portion 21, and a connecting portion 23 bending outwardly from a lower edge of the retaining portion 21. The resilient contacting arm 22 defines a first contacting portion 221 having a dimple 222 thereon at a free end thereof. Each first contact 2 is inserted into a corresponding first terminal groove 121 to be retained in the first housing 1 by the retaining portion 21 engaging with the side wall 12, the resilient contacting arm 22 runs through the inner face 120 to set the first contacting portion 221 disposed in the mating cavity 13, and the connecting portion 23 extends out of the first housing to be soldered to a printed circuit board. The first contacting portions 221 expose upon the round inner face 120 of the side wall 12 to surround the mating cavity 13.

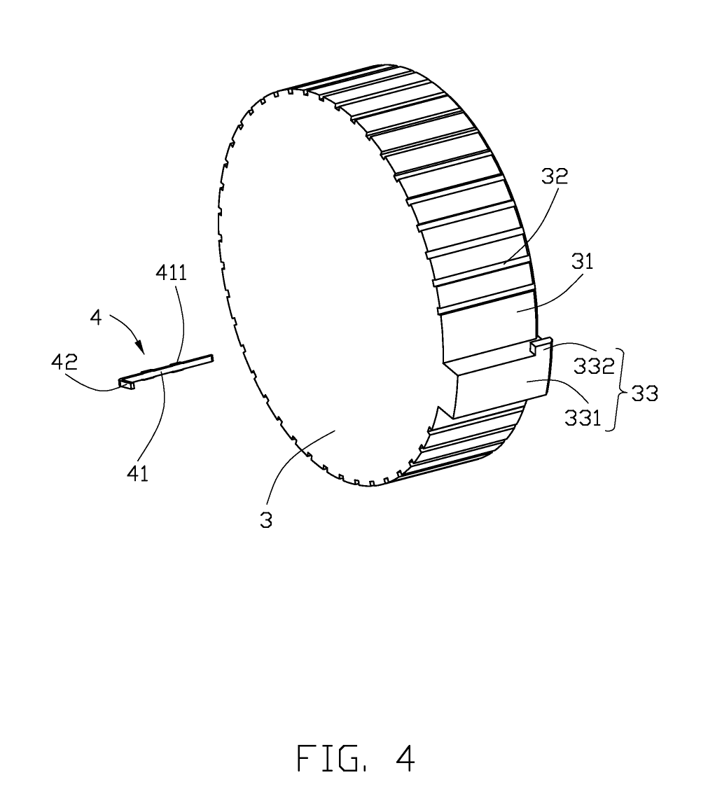

Referring to FIG. 2 and FIG. 4, the second connector 200 defines a circular second insulative housing 3 having an outer face 31 thereof and a plurality of second contacts 4 retained to the second housing 3. In this embodiment, only one second contact 4 is shown in the second connector 200. The second housing 3 provides a plurality of second terminal grooves 32 recessed from the outer face 31 thereof, and a second locking portion 33 projecting outwardly from the outer face 31. The plurality of second terminal grooves 32 symmetrically arrange along the outer face 31. The second locking portion 33 defines a rectangular base portion 331 and a latching portion 332 projecting from the base portion 331. Each second contact 4 defines a stiff second contacting portion 41 with barbs 411 at two opposite side edges thereof, and a soldering leg 42 bending from the second contacting portion 41. Each second contact 4 is retained in a corresponding second terminal groove 32 by the barbs 411 engaging with second housing 3, the second contacting portion 41 exposes upon the outer face 31, and the soldering leg 42 extends out of the second housing 3.

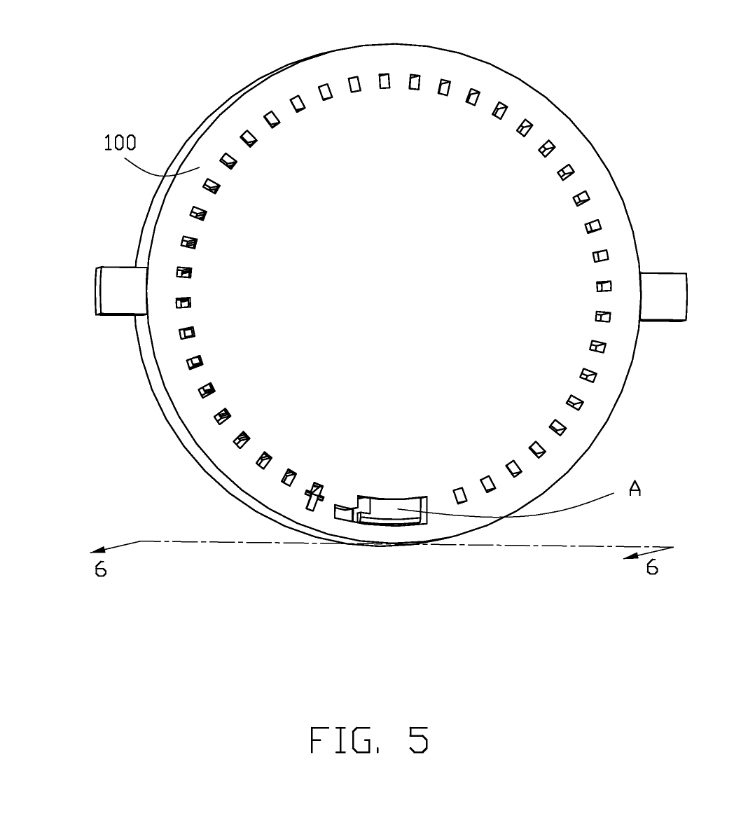

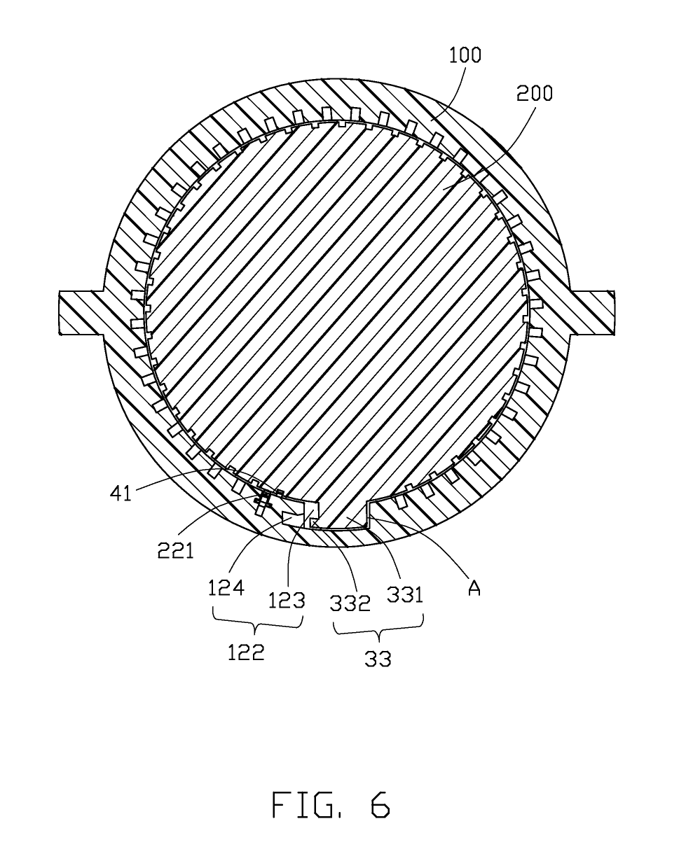

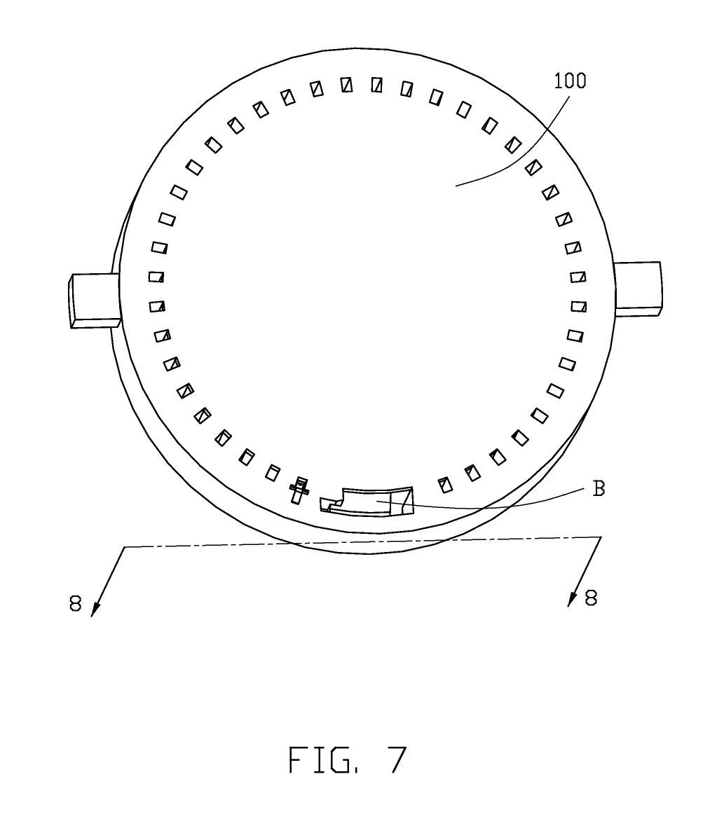

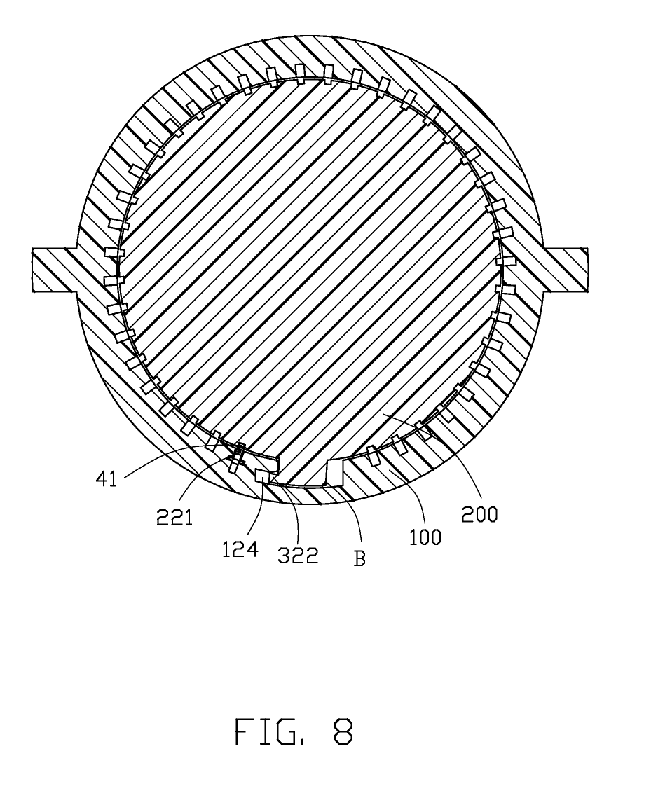

Referring to FIG. 5 to FIG. 8, when the first connector 100 mates with the second connector 200, the second connector 200 is inserted into the mating cavity 13 to stay at a first position A, in which the second locking portion 33 is received in the receiving slot 123 to be unlocked with the first locking portion 122, and the second contacting portion 41 of the second contact 4 is disconnected with the first contacting portion 221 of the first contacts 2; then rotate the second connector 200 relative to the first connector 100 to dispose the second connector 200 stay at a second position B, in which the latching portion 332 runs into the locking slot 124, synchronously, the second contacting portion 41 of the second contact 4 and the first contacting portion 221 of the first contacts 2 mechanically and electrically contacted with each other to make the first and second connectors 100, 200 contact and lock in place. In other wards, the second connector 200 can be inserted into the mating cavity 13 to stay at the first position A and then rotated to stay at the second position B to make the first and second connectors 100, 200 synchronously contact and lock in place, which can achieve reliably locking feature and excellent electrical transmission therebetween.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1-7. (canceled)

8. A first connector for receiving a second connector rotatable relative to the first connector from a first position to a second position, the first connector comprising:
a first insulative housing defining a circular side wall and a mating cavity surrounded by the side wall; and
a plurality of first contacts retained in the side wall and providing a plurality of first contacting portions projecting into the mating cavity from the side wall;
wherein the side wall defines a first locking portion thereof for locking with the second connector when the second connector stays at the second position; wherein
the first housing defines a bottom wall from which the side wall rose along a mating direction, the mating cavity is formed by the side wall and the bottom wall commonly; wherein
each first contact defines a retaining portion, a resilient contacting arm bending inwardly from an upper portion of the retaining portion, and a connecting portion bending outwardly from a lower edge of the retaining portion, and each first contacting portion is provided around a free end of the resilient contacting arm; wherein
the connecting portion of the first contact is exposed around the bottom wall, and said first locking portion includes a receiving slot and a locking slot which transversely communicates with the receiving slot and is located in the bottom wall and downwardly exposed to an exterior.

9. The first connector as described in claim 8, wherein the first contacts mechanically and electrically contact with the second connector when the second connector stays at the second position.

10. The first connector as described in claim 8, wherein the first locking portion defines a receiving slot running through both an upper face of the side wall and an inner face of the side wall to communicate with the mating cavity, and a locking slot set in the side wall to communicate with the receiving slot and closed at an upper portion thereof.

11. The first connector as described in claim 8, wherein the first contacting portions are symmetrically arranged around the mating cavity.

12-13. (canceled)

14. A method of making electrical connection between two electrical connectors, comprising steps of:
providing a first electrical connector with a first insulative housing with a plurality of first contacts therein, wherein the first insulative housing having a cylindrical interior mating face with a cylindrical receiving cavity therein, and said first contacts are exposed upon said cylindrical interior mating face to face said cylindrical receiving cavity;
providing a second electrical connector with a second insulative housing with a plurality of second contacts therein, wherein the second insulative housing having a cylindrical exterior mating face with said second contacts exposed thereon; and
initially inserting said second insulative housing into said cylindrical receiving cavity in an axial direction, along which both said first insulative housing ands said second insulative housing are coaxially extend, and successively rotating said second insulative housing with a predetermined angle to have each pair of the first contacts and the second contacts aligned and mated with each other in a radial direction;
further including a step of providing locking means upon the first insulative housing and the second insulative housing wherein said locking means allows the first insulative housing to be inserted, in the axial direction, into the cylindrical receiving cavity at a predetermined radial position freely and rotated with said predetermined angle to a final locking position for locking the first insulative housing and the second insulative housing together without relative axial movement; wherein
said locking means forms a locking slot in said cylindrical interior mating face and a locking protrusion on the cylindrical exterior mating face; wherein
said locking means provides not only locking against withdrawal of the second insulative housing from the first insulative housing in the axial direction but also locking against further rotation of the second insulative housing with regard to the first insulative housing beyond said predetermined angle; wherein
said locking slot is formed in a bottom face of the first housing and downwardly exposed toward an exterior.

15-16. (canceled)

17. The method as claimed in claim 14, wherein said first contacts are deflectable while said second contacts are stationary.

18-19. (canceled)

20. The method as claimed in claim 14, wherein each of said first contacts has a tail exposed upon the bottom face of the first insulative housing, and each of said second contacts has another tail exposed around a top face of the first insulative housing opposite to said bottom face in the axial direction.
